(19) United States
(12) Patent Application Publication
(10) Pub. No.: US 2022/0147933 A1
(43) Pub. Date: May 12, 2022

(54) SYSTEMS AND METHODS FOR CHARACTERIZING WORK BY WORKING EQIUPMENT BASED ON PROXIMITY TO A WORKER'S COMPUTING DEVICE

(71) Applicant: Moovila, Inc., Mount Pleasant, SC (US)

(72) Inventors: Mike Psenka, Sullivan's Island, SC (US); Brian Duncan, Charleston, SC (US); Jeremiah Huston, Ladson, SC (US)

(21) Appl. No.: 17/092,155

(22) Filed: Nov. 6, 2020

(51) Int. Cl. G06Q 10/10; H04W 4/02; G06F 16/9038; G06Q 10/06; G06Q 50/08; H04W 4/029

(52) U.S. Cl. CPC G06Q 10/10; H04W 4/023; H04W 4/029; G06Q 10/063; G06Q 50/08; G06F 16/9038

(57) ABSTRACT

Systems and methods for characterizing work by working equipment based on proximity to a worker's computing device are disclosed. According to an aspect, a system includes a first computing device configured to determine whether the first computing device is located within a predefined distance from working equipment. The first computing device is also configured to communicate notification whether the first computing device is located within the predefined distance from the working equipment. The system also includes a second computing device configured to receive the notification. The second computing device is also configured to determine characterization of work by the working equipment based on the received notification.

### TECHNICAL FIELD

The presently disclosed subject matter relates generally to working equipment monitoring. Particularly, the presently disclosed subject matter relates to systems and methods for characterizing work by working equipment based on proximity to a worker's computing device.

### BACKGROUND

Heavy working equipment or machinery include various vehicles used for implementing construction tasks, such as earthwork operation or other major construction tasks. Such heavy working equipment can include excavators, loaders, haulers, and demolition equipment. Heavy working equipment can be used for projects such as building construction, infrastructure construction, and industrial construction.

Construction costs can be very expensive, and this is due in large part to the costs of operating heavy working equipment. For this reason, it is important to track the use of the equipment, such as the amount of time the equipment was used on a task. Then the cost of the equipment as compared to its use can be evaluated. Although various techniques are used to track equipment use, these techniques have been inaccurate and inconvenient to use. Therefore, there is a continuing need for improved systems to track working equipment.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a diagram of a system operable to characterize work by working equipment based on proximity to a worker's computing device in accordance with embodiments of the present disclosure;

FIG. 2 is a flow diagram of a method for characterizing work by working equipment based on proximity to a worker's computing device in accordance with embodiments of the present disclosure;

FIG. 3 is a diagram depicting a working equipment data collection and transmission system in accordance with embodiments of the present disclosure;

FIG. 4 is a screen display showing a displayed user interface for viewing a photograph and identifying the geofenced areas of the construction site; and

FIG. 5 is a flow diagram of office BLE data quantification in accordance with embodiments of the present disclosure.

### SUMMARY

The presently disclosed subject matter relates to systems and methods for characterizing work by working equipment based on proximity to a worker's computing device. According to an aspect, a system includes a first computing device configured to determine whether the first computing device is located within a predefined distance from working equipment. The first computing device is also configured to communicate notification whether the first computing device is located within the predefined distance from the working equipment. The system also includes a second computing device configured to receive the notification. The second computing device is also configured to determine characterization of work by the working equipment based on the received notification.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth wireless technology, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. BLUETOOTH®. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

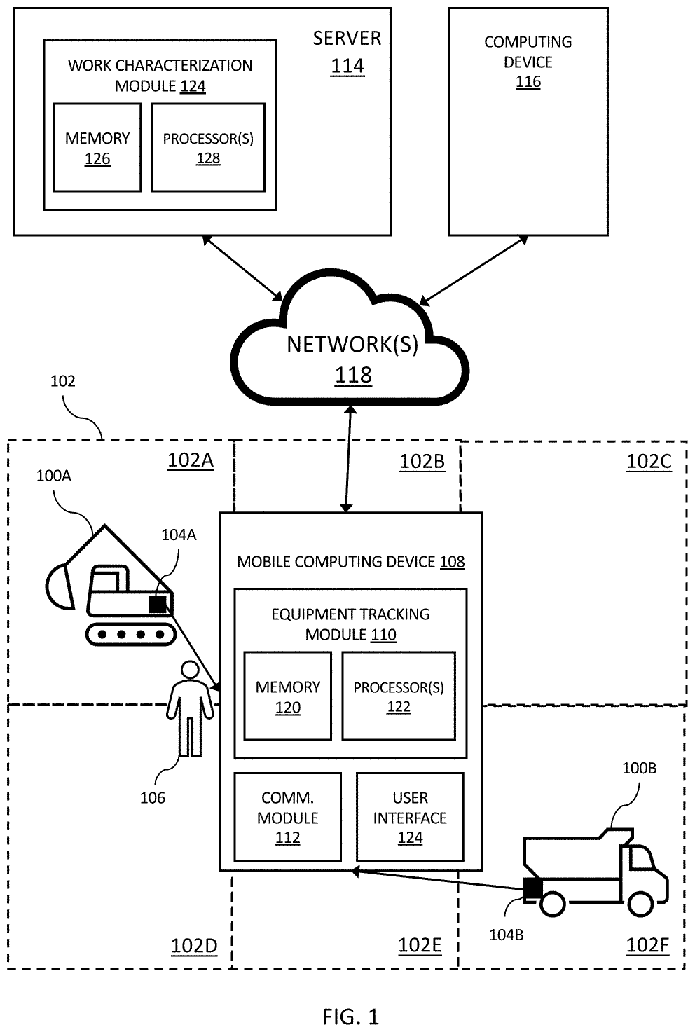

FIG. 1 illustrates a diagram of a system operable to characterize work by working equipment based on proximity to a worker's computing device in accordance with embodiments of the present disclosure. Referring to FIG. 1, there are two (2) working equipment 100A and 100B at a construction site 102 (the boundaries of which are generally depicted by the outside perimeter of the grid of broken-lined rectangles), although it should be understood that any suitable number of working equipment and type of working equipment may be in the environment. In this example, working equipment 100A is an excavator, and working equipment 100B is a truck.

Working equipment 100A and 100B have computing devices 104A and 104B, respectively, attached thereto or otherwise associated therewith. For example, the computing devices 104A and 104B may be carried by its respective working equipment 100A and 100B. Each computing device 104A and 104B is configured to determine its location. For example, computing device 104A and 104B may include a global positioning system (GPS) receiver or other device operable to determine its current location. Further, the computing devices 104A and 104B may each include a wireless communication module operable to communicate with another computing device. For example, the wireless communication module may be a Bluetooth wireless technology system for short range communication with another computing device.

A worker 106 is located at the construction site 102 and carrying a mobile computing device 108. The computing device 108 is configured to determine whether it is located within a predefined distance from working equipment, and to communicate notification whether the computing device 108 is located within the predefined distance from the working equipment. For example, the computing device 108 carried by the worker 106 includes an equipment tracking module 110 configured to receive wireless communications from the computing devices 104A and 104B or other computing devices. The wireless communication may be received by a communications module 112 of the computing device 108. The communications module 112 may be configured to receive and process Bluetooth communication signals and/or other communication signals. Based on a received wireless communication, the equipment tracking module 110 may determine whether the transmitting computing device (e.g., computing device 104A or 104B) is located within a predefined distance (e.g., within 2 meters). Thus, based on this determination, the equipment tracking module 110 is able to deduce whether the worker 106 carrying the computing device 108 is associated with the working equipment of the transmitting computing device (e.g., utilizing the working equipment).

Upon determining that a computing device of working equipment is within the predefined distance, the equipment tracking module 110 can use the communications module 112 to communicate notification, to a remote server 114 or other computing device 116, whether the computing device of working equipment is within the predefined distance. For example, the notification can be communicated to the server 114 or computing device 116 via one or more communications networks 118. The server 114 or other computing device 116 can determine characterization of work by the working equipment based on the received notification. For example, the characterization of work can include, but is not limited to, an estimate of an amount of time that the working equipment was operating, a type of job that the working equipment performed during the estimated amount of time, and the like. In an example, the determinization of the characterization of work can be determined at the server 114 and this information subsequently sent to the computing device 116 via the network(s) 118. The computing device 116 may be utilized by a manager of the worker 106 or another individual responsible for monitoring the usage of the working equipment.

Functionalities of the equipment tracking module 110 described herein may be implemented by hardware, firmware, software, or combinations thereof. For example, the module 110 may be include memory 120 and one or more processors 122 that implement instructions residing in the memory 120. The computing device 108 may include a user interface 124 for use in interacting with the worker 106 or others.

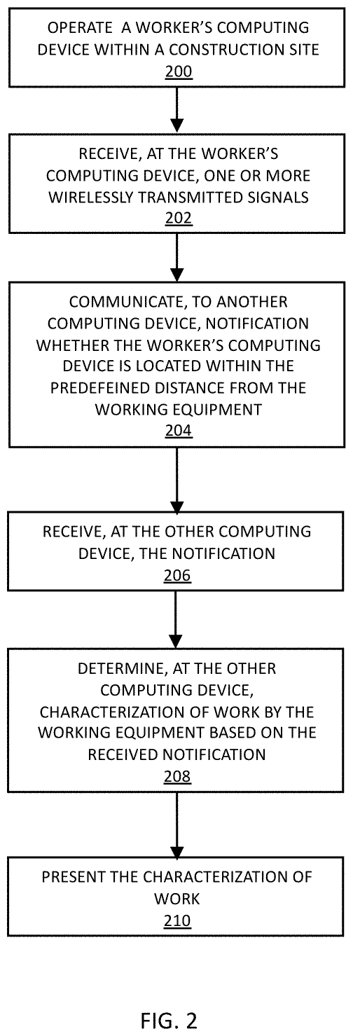

FIG. 2 illustrates a flow diagram of a method for characterizing work by working equipment based on proximity to a worker's computing device in accordance with embodiments of the present disclosure. The method is described by example as being implemented by the system shown in FIG. 1, although it should be understood that the method may be implemented by any other suitable system.

Referring to FIG. 2, the method includes operating 200 a worker's computing device within a construction site. For example referring to FIG. 1, the work 106 may carry the computing device 108 to the construction site 102. The worker's computing device 108 may be turned on and its equipment tracking module 110 may be activated.

The method of FIG. 2 includes receiving 202, at the worker's computing device, one or more wirelessly transmitted signals. Continuing the aforementioned example of FIG. 1, the worker's computing device 108 may receive communication signals at the communications module 112 when in range of a transmitter of communication signals. Particularly, the computing devices 104A and 104B associated with the excavator 100A and the truck 100B, respectively, may periodically or continuously shortrange communication signals. The computing devices 104A and 104B may be, for example, include communication modules operable to implement Bluetooth wireless technology for sending shortrange communication signals. In an example, the computing devices 104A and 104B may include a Bluetooth low energy (BLE) device. The communications module 112 of the worker's computing device 108 may receive one or both of the signals while located at the construction site 102 depending on the proximity of the computing device 108 to the computing devices 104A and 104B. For example, the range of Bluetooth wireless communication can be up to 100 meters or greater. Notification and data relating to receipt of wireless signals at the communication module 112 may be reported to the equipment tracking module 110 for processing in accordance with embodiments disclosed herein.

The method of FIG. 2 includes determining 204, based on the received signal(s), whether the worker's computing device is located within a predefined distance from working equipment. Continuing the aforementioned example, the equipment tracking module 110 can receive the notification and data relating to receipt of wireless signals from the communications module 112. The equipment tracking module 110 can determine or estimate a distance to the computing device that transmitted the received wireless signal based on the received notification and/or data. For example, the received data may indicate a strength of the wireless signal, and the equipment tracking module 110 can be configured to determine a distance or approximate distance to the transmitting computing device based on the strength of the wireless signal. Particularly, for example, the received signal may be from a BLE device, and the equipment tracking module 110 may be configured to determine a distance or approximate distance to the BLE device based on the received signal data according to techniques understood by those of skill in the art. More generally, the equipment tracking module 110 can determine whether the transmitting device is located within a predefined distance (e.g., 2-5 meters) based on the received signal, and thereby can determine whether working equipment (e.g., working equipment 100A or 100B) is within the predefined distance based on the signal received from the computing device (e.g., computing device 104A or 104B) associated with the working equipment.

The received signal may include an identifier of the working equipment (e.g., working equipment 100A or 100B) or a suitable type of indicator of the working equipment associated with the transmitting computing device. For example, the computing device 104A may store an identifier that uniquely identifies the working equipment 100A. This identifier may also be stored at other computing devices, such as server 114 and/or computing device 116, for use in tracking and managing usage of the working equipment 100A in accordance with embodiments disclosed herein. A wireless signal transmitted from the computing device (e.g., computing device 104A or 104B) may include or carry the identifier that identifies its associated working equipment (e.g., working equipment 100A or 100B).

The method of FIG. 2 includes communicating 204, to another computing device, notification whether the worker's computing device is located within the predefined distance from the working equipment. Continuing the aforementioned example, the equipment tracking module 110 may communicate to the server 114 notification whether the worker's computing device 108 is located within the predefined distance from the working equipment 100A. The method of FIG. 2 includes receiving 206, at the other computing device, the notification. For example, the server 114 may receive the notification.

The method of FIG. 2 includes determining 208, at the other computing device, characterization of work by the working equipment based on the received notification. Continuing the aforementioned example, the server 114 may include a work characterization module 124 including hardware, software, firmware or combinations thereof for implementing the functionalities described herein. For example, the work characterization module 124 can include memory 126 and one or more processors 128 for implementing the functionalities described herein. The work characterization module 124 can be configured to determine characterization of work by working equipment 108A based on the received notification. For example, the work characterization module 124 can determine an amount of time that the worker's computing device 108 was within the predefined distance of the excavator 100A based on received notification. Based on this determination of the amount of time, the module 124 can estimate that the working equipment was operating, by use of the worker 106, for the amount of time. Also, the module 124 can determine a type of job performed during the time based on the type of working equipment used. For example, the module 124 can determine that excavation work was being done during the amount of time since the working equipment 100A is an excavator. This may be determined based on an identifier received from the computing device 104A.

The method of FIG. 2 includes presenting 210 the characterization of work. Continuing the aforementioned example, a user interface of the server 114 can display the characterization of work. For example, the user interface may display an amount of time, an identifier of the working equipment, and a type of work performed. Further, the server 114 can communicate data of the characterization of work to the computing device 116 via the network(s) 118, and the computing device 116 may use its user interface to present the characterization of work. Further, the server 114 or computing device 116 may generate content for presentation to a user about the determined characterization of work by the working equipment.

In accordance with embodiments, the worker's computing device 108 and/or the computing devices 104A and 104B can determine their location (e.g., geographic coordinates). Upon sending a notification to the server 114, the mobile computing device 108 can also send, to the server 114, information about the current or recent location of the computing device 108 and/or the computing device 104A, 104B being reported with the notification. The determined location can be associated with the determined characterization of work. For example, the construction site 102 may have multiple different areas or work sites 102A-102F where different subject projects are being performed. The works sites 102A-102F may be defined by geofences. Based on the determined location, it can be determined that the working equipment is within one of the areas 102A-102F and therefore it can be determined or deduced that the working equipment is being used on the particular project within the determined area 102A-102F.

In accordance with embodiments, data may be collected from BLE devices, the data may be stored on the server, and the data may be analyzed to determine characterization of work by working equipment. The characterization of work can include, but is not limited to, the operating times and duration of the working equipment, the location of the working equipment during that operation, the project or task being performed during the operation, working time for the working equipment, and idle time for the working equipment. This information may be presented in the form of various reports, including a report indicating which equipment has not been located within a predefined time period.

In accordance with embodiments, computing devices, such as computing devices 104A and 104B, may be suitably placed or attached on any suitable type of working equipment. In examples, the computing devices can be BLE devices attached to any type of working equipment, even if the equipment already has a telematics blackbox device wired to it. A BLE device for use in accordance with embodiments disclosed herein ca be placed on any equipment to be tracked, unless telematics data for the equipment is already readily available at an acceptable collection and transmission frequency (e.g., 15 minutes or less). In examples, the BLE device can be placed at a location on the working equipment such that the device is close to where the operator is expected to be sitting, and the BLE device can be configured for protection from accidental damage. An example location for the BLE device is behind the operator's seat, thus it can be expected to be in proximity to the worker's computing device when the worker is operating the working equipment. Note that it is not necessary for the BLE device to transmit to a server, rather the worker's computing device can do so. Therefore, GPS signal should not be a consideration for the placement.

A BLE device can be positively associated with working equipment subsequent to the BLE device being attached to the equipment. This can prevent incorrect configuration of the devices. Subsequent to attaching the BLE device to the working equipment, the installer can bring up a device configuration module. Using this module, the worker can perform one of the following two steps: device scanning mode; and QR code scanning mode. In the device scanning mode, this mode can begin scanning for devices within 2 meters of the installer's phone. When the installed device is read, the installer can choose which equipment is associated with the device. In the QR code scanning mode, the BLE devices can have a QR code containing the device's ID affixed to it. Using the QR scanning mode, the installer will scan the QR code affixed to the BLE device. Then the installer will choose which equipment is associated with the scanned device.

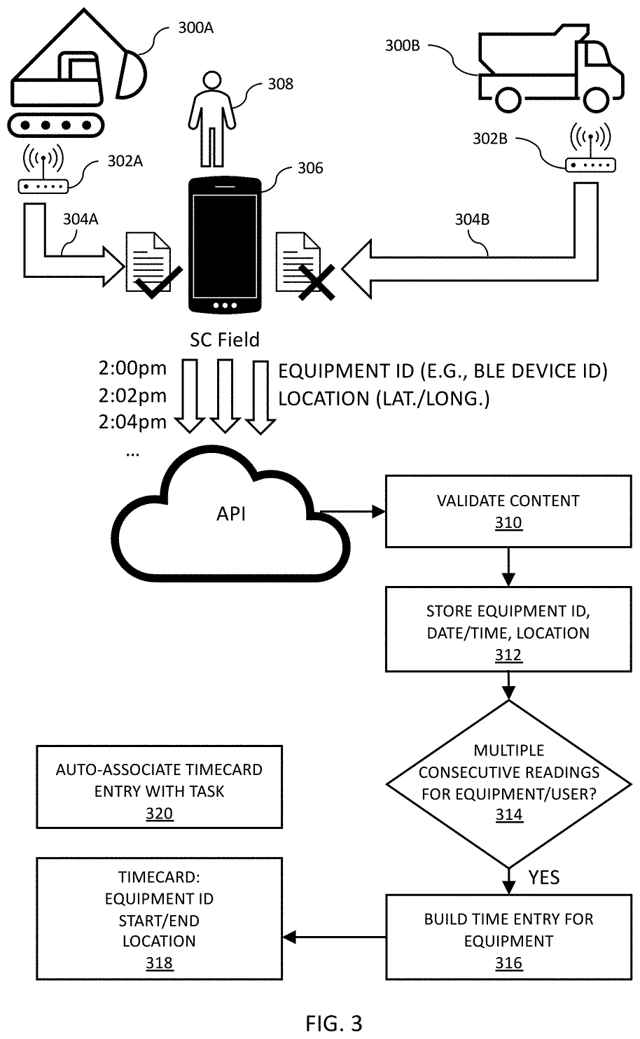

FIG. 3 illustrates a diagram depicting a working equipment data collection and transmission system in accordance with embodiments of the present disclosure. Referring to FIG. 3, the system includes working equipment 300A (an excavator) and 300B (a truck) having computing devices 302A and 302B, respectively, attached thereto. The computing devices 302A and 302B are BLE-enabled devices that are communicating wireless signals 304A and 304B, respectively, in accordance with embodiment of the present disclosure. A computing device 306 carried by a worker 308 can scan for and receive the wireless signals 304A and 304B.

In this example, the computing device 306 is positioned sufficiently close to the computing devices 302A and 302B such that both signals 304A and 304B are received, but the computing device 306 is positioned less than 2 meters away from the computing device 302A and greater than 2 meters away from the computing device 302B. The computing device 306 can estimate the distances based on a strength of each signal. The computing device 306 can subsequently process the data from the computing device 302A in response to determining that it is closer than 2 meters or otherwise positioned closely to the computing device 306. Also, the computing device 306 can subsequently reject or ignore the data from the computing device 302B in response to determining that it is further than 2 meters or otherwise positioned further than a predefined position from the computing device 306.

In accordance with embodiments, the computing device 306 can verify the identity and quality of the received signal 304A. Further, the computing device 306 can transmit the data to a remote server (e.g., server 114 shown in FIG. 1). Further, the computing device 306 can periodically send a keep-alive message to the server, and the data can persist on the server.

In accordance with embodiments, the computing device 306 may include a scanning module, which may be part of the equipment tracking module 110 of the computing device 108 shown in FIG. 1. In an example, the computing device may implement an application, referred to as the “Moovila Mobile” application. Once the user logs into the Moovila Mobile application, the scanning module can start, and can run in the background on the computing device 306. The module can scan for BLE devices (e.g., computing device 104A and 104B that each have BLE devices) on a periodic basis. This scanning period may be no longer than every 15 minutes. When a BLE device's signal is received by the scanning module, the next step can be to verify the signal.

Once a BLE signal is received, the scanning module can verify that the device found is trackable. Verification may be performed by use of one or more checks. For example, an identifier (ID) of the BLE device can be compared to a list of identifiers currently associated with known working equipment. In this example if the identifier is not found in the list, then the signal can be discarded. In another example, a strength of the signal from the BLE device can be used to determine the proximity of the worker's computing device (or the worker) to the working equipment associated with the BLE device. In this example if the signal strength indicates that the worker is farther than 2 meters away from the device, the signal can be discarded.

Once the data has been collected and verified by the computing device 306, then this data can be transmitted to the server. Data sent to the server can include, but is not limited to a user session identifier (i.e., the current active session of the user), device identifier (i.e., the ID of the BLE device), signal strength/worker proximity (i.e., the distance that the worker is from the BLE device), location (i.e., the current GPS location of the worker's computing device), and date/time (i.e., the date and time of the signal receipt).

At the server when the data is received, the server can validate the identity of the user session and the content of the message 310. By validating the identity of the user session, it can be ensured that the user transmitting data is a valid user of the system. By validating the content of the message, it can be ensured that the data transmitted is appropriate for the user doing the transmission, and that the quality and context is valid. In an example, a user may be anonymized by converting the userGUID to a one-way hash for ensuring that the user's PII is not stored during this operation. This data (e.g., working equipment ID, date/time, and location) can be stored 312 in the server's database. A message can be sent to an analysis engine to indicate that new data has been retrieved for triggering analysis of the data.

With respect to data analysis, the analysis engine can be an asynchronous service that runs on the server, waiting for messages to be received from BLE devices. When messages are received, the engine can perform analysis on the data, attempting to extrapolate usage information. The engine can attempt to determine the following example information about the equipment: equipment operating times/duration; location of the equipment during that operation; project that should be associated with each period of operation; and task that was being performed during each period of operation. This information can be determined based on one or more factors. This engine can be used in conjunction with a worker time entry analysis engine. Many of the business rules can apply to both engines. Whenever this engine runs, it can analyze the current added entry. In addition, it can also re-analyze certain other entries that have not been successfully matched with projects/tasks.

The following definitions are referenced in the below example rules:
Qualified Reading—A BLE message was sent to the server with a signal strength indicating that the worker was within 2 meters of the equipment.
Qualified Timespan—Multiple consecutive qualified readings occurred for a piece of equipment from the same worker within a 15-minute increment. For example, the step of determining 314 whether multiple consecutive readings are received for the equipment/user can be implemented. In the example of FIG. 3, signals from the computing device 302A are received at the times 2:00 pm, 2:02 pm, 2:04 pm, etc. so these would qualify as multiple consecutive readings from the equipment. In response to this determination, a time entry may be built 316 for the working equipment. A timecard may be generated 318 with data including, but not limited to, working equipment ID, start/end times, and location. Further, the timecard may be associated 320 with a task.
Qualified Task—A project task is available to be worked at that time. (i.e., any dependencies were cleared before that time).
Equipment in Motion—A qualified Timespan contains multiple locations that are farther from each other than 4 meters, with no obvious clustering within Task geofence locations.
Time Entry—A record for the equipment that contains a duration of one or more qualified timespans involving the same worker.
Qualified Location—The location determined for a time entry.
Geofence Match—The task's geofence is within 10 meters of a qualified location.

In accordance with embodiment, an operating date and time of working equipment can be determined. For example, the work characterization module 124 of the server 114 can estimate a start and end date/time of working equipment's operation. This may be an estimate with a 15 minute increment. Multiple qualified timespans can be combined into one larger time entry for that equipment. One or more rules may be utilized for this determination. Example rules follow:
Only qualified readings may be considered.
A qualified timespan for the equipment indicates the equipment was being used by the worker.
Other BLE readings from that same worker during the same timespan can be excluded, as long as they are not part of another qualified timespan.
If the location of the equipment moves between geofences of multiple tasks, the time entries and task associations may be split on a qualified timespan basis (i.e., minimum of 15 minute granularity).
   Various strengthening factors to the determination include, but are not limited to:
The equipment was determined to be equipment in motion.
The worker is a known operator of that equipment.
The worker's time entries for that time period indicate that they are working on a cost code that matches qualified tasks that contain an association with that equipment.
The equipment's location is within a geofence match of a qualified task.
   A weakening factor to the determination includes, but are not limited to, the user also being involved in another qualified timespan that overlaps this qualified timespan.

In accordance with embodiments, various rules may be applied to determine the working equipment's primary location within a qualified timespan. Example rules include, but are not limited to:
If all location readings for the BLE readings for a qualified timespan are within 5 meters, the average location within the readings can be used as the qualified location for the associated time entry.
If the qualified timespan contains multiple locations farther apart than 5 meters, and these locations form more than one cluster of locations, then that timespan will be separated into multiple time entries, for each clustered location.

In accordance with embodiments, a time entry may be associated with a project. Example rules for this association include, but are not limited to:
Determine whether the location of the time entry is within the bounds of a project geofence.
Determine whether other time entries for this equipment have been associated with a project recently.
Determine whether the worker associated with the time entry has worker time entries associated with this project.

In accordance with embodiments, each time entry may be associated with a qualified task based on one or more of the following strengthening factors:
There is one and only one geofence match for the time entry.
A task for a geofence match has that equipment defined as an item.
A task for a geofence match has other time entries already associated with it for that equipment.
A task for a geofence match has worker time entries associated with the same user that was associated with the qualified timespans within that time entry.
   Weakening factors include, but are not limited to:
There are no geofence matches for the time entry.
There are multiple geofence matches for the time entry.

In accordance with embodiments, systems disclosed herein may implement exception tracking and reporting. In an example, a report may be generated for BLE devices or their associated computing devices that have not been received by a BLE scanning module within a predetermined time period (e.g., a number of days). This may indicate a damaged BLE device, a dead battery in the BLE device, or other issue with the device. In embodiments, the BLE scanning module for each worker will send a message to the server at least every hour. This can either include a reading of a BLE device, or a keep-alive message if a device hasn't been read within an hour. If a worker's BLE scanning module does not send a message to the server within 24 hours, that worker can appear on a report indicating that there is an issue with the worker's scanning module. For non-associated working equipment exceptions, a report can be generated that contains a list of all equipment that is utilized for a project, but that does not contain an active configuration for either a BLE device or a standard telematics device. For non-associated device exceptions, a report can be generated that contains a list of all BLE devices registered that are not currently associated with an active piece of equipment. In an example, a map can be generated that shows the last known location of all tracking equipment.

Due to the nature of construction work, it may be likely that the mobile devices utilized by the workers are frequently unable to access cellular networks, preventing them from immediately transmitting data to the server. When this happens, the data to be transmitted will be kept on the mobile device. When the mobile device is capable of transmitting to the server again (e.g., when the worker has left the jobsite), the messages can be transmitted in a batch to the server. It is noted that when messages are stored in this manner, they should be persisted in local storage on the mobile device. This ensures that if the device is rebooted, or the battery runs out, the data will not be lost.

Occasionally, if a worker's device goes beyond a defined period of time without reading a BLE device, the worker's device can send a ‘Keep-Alive’ message to the server, indicating that the worker's device is still operational and scanning for devices. By necessity, this message can contain the userGUID of the worker. However, the location of the worker's phone is not sent to the server in this message. This can prevent unnecessary tracking of worker location outside the proximity of the jobsites.

In accordance with embodiments, another example method for characterizing work by working equipment based on proximity to a worker's computing device is disclosed with respect to FIG. 1. As an initial step, a user, such as the worker 106, can arrive at the construction site 102. The worker 106 can enter the cab of the excavator 100A. Subsequently, the computing device 108 can scan a beacon transmitted by the computing device 104A and send the ID and GPS location (e.g., geofenced area 102A) in the beacon to the server 114. The worker 106 can operate the excavator 100A for a period of time, such as 2 hours. During this period of time, the beacon continues to be transmitted by the computing device 104A and scanned by the worker's computing device 108. The beacon can be scanned periodically, such as every 2 minutes. Subsequently, after the period of time, the worker 106 can move the excavator 100A to another location (such as from geofenced area 102A to geofenced area 102B). Information about the new location can be sent from the computing device 104A to computing device 108, which relays the identification of the new location to the server 114. At the new location (e.g., area 102B), the worker 106 can operate the excavator 100A for a time period of 3 hours and then exit the cab of the excavator 100A. This time period can also be reported to the server 114. After exiting the cab of the excavator 100A, the computing device 108 stops receiving the beacon because it is out of range of the beacon. Then this information is processed and sent to the server 114.

Table 1 below provides example time entry information for the User (or worker) John at different locations identified as “A” and “B” for a machine (or working equipment) with the identifier “E089”.

TABLE 1

| Machine | Location | User | Time |
|---|---|---|---|
| E089 | A | John | 7:15a |
| E089 | A | John | 7:17a |
| E089 | A | John | 7:19a |
| . | . | . | . |
| E089 | B | John | 9:20a |
| E089 | B | John | 9:22a |
| E089 | B | John | 9:24a |
| . | . | . | . |
| E089 | B | John | 12:20p |

Continuing with the example, the readings may be quantified into working hours, and the machine (or working equipment) time cards are generated as shown in the example of Table 1. GPS locations are associated with time cards (e.g., represented by A and B in the example). Further, the time card location can be compared to project geofences and this information used to determine a project task.

Table 2 below shows example information for a machine time card generated based on the information of Table 1. The project task is determined based on the location, i.e., working time spent by machine E089 at location A means that the project is “Dig Retention Pond”, and working time spent by machine E089 at location B means that the project is “Rough Cut Road 1”.

TABLE 2

| Machine | Working Hours | Location | Project Task |
|---|---|---|---|
| E089 | 2 hr. 5 min. | A | Dig Retention Pond |
| E089 | 3 hr. 0 min. | B | Rough Cut Road 1 |

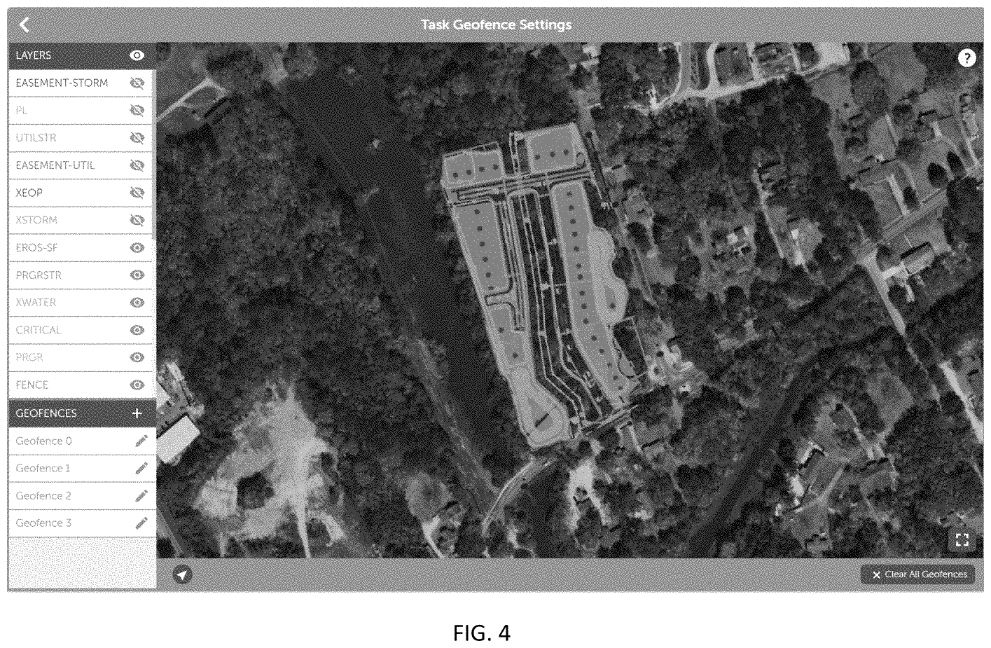

Continuing with the example, FIG. 4 is a screen display showing a displayed user interface for viewing a photograph and identifying the geofenced areas of the construction site.

In embodiments, a BLE device can be configured to transmit both iBeacon and Eddystone packets at the same time. The BLE device can allow a separate txPower setting for iBeacon than for Eddystone. Further, the BLE device can be constructed such that it is waterproof. In an example, identifiers can be assigned in ranges, the major and minor from a beacon configured with Eddystone must match one that is configured for beacon, i.e. Major+Minor==InstanceID. These two beacons can be considered a pair and can go on a single device.

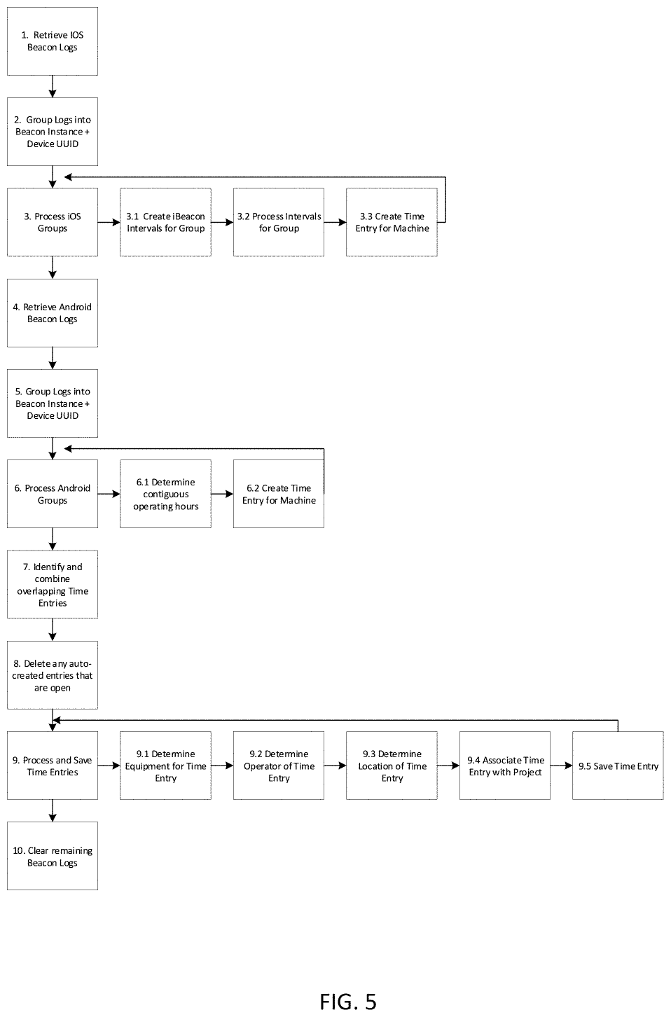

FIG. 5 illustrates a flow diagram of office BLE data quantification in accordance with embodiments of the present disclosure. Referring to FIG. 5, iOS beacon logs are retrieved at Step 1. In this step, OSTypeCode=1, RSSI is null, and BeaconInstance< >Family. At Step 2, group iOS logs in Beacon ID+Device UUID.

At Step 3, iOS groups are processed. This includes creating iBeacon intervals for the group (Step 3.1), processing intervals for the group (Step 3.2), and creating time entry for the machine (or working equipment) (Step 3.3). At Step 3.1, an interval can span between a iBeacon “Found” event until the next iBeacon “Lost” event. At Step 3.2, iOS interval sets are created. All intervals can be grouped together that are within 10 minutes of each other. The interval sets can be split into different groups if the interval is greater than 10 minutes apart. At Step 3.3, for each iOS interval set, if the total time for interval group is greater than or equal to 15 minutes, time entry is created. If the total time for interval group is less than 15 minutes, then ignore.

At Step 4, Android beacon logs are retrieved. Here, the Android beacon logs are retrieved for enterprise (OSTypeCode=2 (Android)).

At Step 5, Android logs are grouped into Beacon ID+Device UUID.

At Step 6, Android Groups are processed. Also, at Step 6.1, contiguous operating hours are processed. Particularly, logs are only considered that have RSSI>=−85. All beacons logs are grouped together that are within 15 minutes of each other. At Step 6.2, a time entry for the machine (or working equipment) is created. For each Android log set, if the total time for the log set is greater than or equal to 15 minutes, a time entry is created. If the total time for a log set is less than 15 minutes, then ignore.

At Step 7, any overlapping time entries are identified and combined.

At Step 8, any auto-created time entries that are open are identified and deleted. Particularly, if there are any auto-created time entries that do not have an end time, the time entry is deleted. It can be recreated with this processing, and may increase the operating time for the entry.

At Step 9, time entries are processed and saved. At Step 9.1, equipment for time entry are determined. This can be determined based on the Beacon ID association with the equipment. At Step 9.2, the operator for the time entry is determined. The operator of the machine can be determined based on the Device UUID of the phone that recorded the beacon log entry. At Step 9.3, the location of time entry can be determined. For example, the latitude and longitude can be determined based on these rules: (1) average the latitude/longitude of all logs associated with this time entry; (2) exclude outliers; (3) determine if there are multiple clusters of locations within the same entry, and if so, split them into multiple time entries; and (4) exclude readings with weak location accuracy values. At Step 9.4, the time entry is associated with a project. Particularly, the project associated with the Time Entry may be determined by the following rules: (1) find project where time entry location is within 50 meters of project geofence perimeter; (2) find project where time entry location is within a 400 meter radius of the project physical address; (3) find manpower timecard for operator worker that overlaps the machine time entry operating hours; and (4) find the most recent time entry for this machine that is associated with a project, and if the time entry was within the last 2 days, use that project.

At Step 9.5, the time entry is saved. If the time entry ended less than an hour ago, create an “open” time entry (has start time but no end time, which indicates that the machine is currently active), and do not mark the beacon logs as processed. If the time entry ended more than 1 hour ago, create a “closed” time entry (has start time and end time, and specifies operating hours), and mark the beacon logs as processed.

At Step 10, the remaining beacon logs are cleared. Particularly, all beacon logs are marked that were not marked as processed if they are more than 2 days old.

In an example scenario, a worker such as worker 106 carrying the computing device 108 shown in FIG. 1, is out of range of any beacon. For example, the computing device 108 may be out of range of either computing device 104A or 104B. Subsequently, the worker 106 goes to the excavator 100A and enters it cab to begin use of the excavator 100A. The worker 106 operates the excavator 100A for 30 minutes without change of location. No other working equipment comes within 50 feet of the computing device 108. After 1 hour, the worker 106 exits the cab and walks out of range while carrying the computing device 108.

In another example scenario, a worker such as worker 106 carrying the computing device 108 shown in FIG. 1, is out of range of any beacon. Working equipment 100A and 100B are next to each other in this example. The worker 106 walks past excavator 100A and spends 15 minutes doing maintenance on truck 100B. Next, the worker 106 gets into truck 100B and drives it 250 feet to the middle of a field. The worker 106 operates the truck for 2 hours while another truck drives nearby. The other truck is being operated by another worker. Subsequently, the worker 106 leaves the truck 100B and walks out of range of the beacon. The result of this scenario is that worker 106 would be recorded as operating truck 100B for approximately 2.25 hours.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A system comprising:
a first computing device being configured to:
determine whether the first computing device is located within a predefined distance from working equipment; and
communicate notification whether the first computing device is located within the predefined distance from the working equipment; and
a second computing device configured to:
receive the notification; and
determine characterization of work by the working equipment based on the received notification.

2. The system of claim 1, further comprising a network, and
wherein the first computing device and the second computing device are configured to communicate via the network.

3. The system of claim 1, wherein the second computing device is a server.

4. The system of claim 1, wherein the first computing device is one of a tablet computer, a smartphone, and a laptop computer.

5. The system of claim 1, wherein the characterization of work comprises an estimate of an amount of time that the working equipment was operating.

6. The system of claim 5, wherein the characterization of work comprises a type of job that the working equipment performed during the estimated amount of time.

7. The system of claim 1, wherein the working equipment is one of construction equipment and earth moving equipment.

8. The system of claim 1, further comprising a third computing device associated with the working equipment and configured to wirelessly communicate with the first computing device, and
wherein the first computing device is configured to determine whether the first computing device is located within the predefined distance from the working equipment based on a strength of communication signal with the third computing device.

9. The system of claim 8, wherein the first computing device is configured to periodically scan for the third computing device to detect whether the third computing device is within the predefined distance.

10. The system of claim 1, further comprising a third computing device associated with the working equipment and configured to wirelessly communicate with the first computing device, and
wherein the first computing device is configured to determine whether a beacon transmitted from the third computing device is within a predefined range for determining whether the first computing device is located within the predefined distance from the working equipment.

11. The system of claim 1, wherein the first computing device is configured to:
determine a location of the working equipment; and
associate the determined location with the determined characterization of work.

12. The system of claim 11, wherein the characterization of work comprises an estimate of an amount of time that the working equipment was operating.

13. The system of claim 11, wherein the first computing device is configured to associate the determined location with the estimated amount of time.

14. The system of claim 11, wherein the first computing device is configured to determine the location of the working equipment based on an acquired satellite positioning coordinate of the working equipment.

15. The system of claim 1, wherein the determined location corresponds to one of a plurality of different work sites for the working equipment.

16. The system of claim 1, wherein the second computing device is configured to generate content for presentation to a user about the determined characterization of work by the working equipment.

17. The system of claim 16, wherein the generated content indicates the determined characterization of work, identifies the working equipment, and an estimated amount of time the working equipment performed the work.

18. The system of claim 17, wherein the second computing device is configured to present the generated content to a user.

19. A method comprising:
determining whether a computing device is located within a predefined distance from working equipment; and
determining characterization of work by the working equipment based on the determination whether the computing device is located within a predefined distance from working equipment.

20. The method of claim 19, wherein the computing device is a first computing device,
wherein the method further comprises
determining, at the first computing device, whether the first computing device is located within the predefined distance from the working equipment; a network; and
communicating, from the first computing device to a second computing device via a network, notification whether the first computing device is located within the predefined distance from the working equipment.

21. The method of claim 19, wherein the second computing device is a server.

22. The method of claim 19, wherein the computing device is one of a tablet computer, a smartphone, and a laptop computer.

23. The method of claim 19, wherein the characterization of work comprises an estimate of an amount of time that the working equipment was operating.

24. The method of claim 23, wherein the characterization of work comprises a type of job that the working equipment performed during the estimated amount of time.

25. The method of claim 19, wherein the working equipment is one of construction equipment and earth moving equipment.

26. The method of claim 19, wherein the computing device is a first computing device, wherein the method further comprises:
wirelessly communicating between a third computing device and the first computing device; and
determining whether the first computing device is located within the predefined distance from the working equipment based on a strength of communication signal with the third computing device.

27. The method of claim 26, further comprising periodically scanning, by the first computing device, for the third computing device to detect whether the third computing device is within the predefined distance.

28. The method of claim 19, further comprising:
receiving, at the first computing device, a beacon transmitted from a third computing device associated with the working equipment; and
determining whether the first computing device is located within the predefined distance from the working equipment based on the received beacon.

29. The method of claim 19, further comprising at the first computing device:
determining a location of the working equipment; and
associating the determined location with the determined characterization of work.

30. The method of claim 29, wherein the characterization of work comprises an estimate of an amount of time that the working equipment was operating.

31. The method of claim 30, wherein the method further comprises associating the determined location with the estimated amount of time.

32. The method of claim 29, further comprising determining the location of the working equipment based on an acquired satellite positioning coordinate of the working equipment.

33. The method of claim 19, wherein the determined location corresponds to one of a plurality of different work sites for the working equipment.

34. The method of claim 19, further comprising generating content for presentation to a user about the determined characterization of work by the working equipment.

35. The method of claim 34, wherein the generated content indicates the determined characterization of work, identifies the working equipment, and an estimated amount of time the working equipment performed the work.

36. The method of claim 35, further comprising presenting the generated content to a user.
